(19) United States
(12) Patent Application Publication
(10) Pub. No.: US 2008/0166677 A1
(43) Pub. Date: Jul. 10, 2008

(54) Light directing and amplifying device

(76) Inventor: Neil John Graham, Long Beach, CA (US)

Correspondence Address: Neil John Graham, 6017 Lido Lane, Long Beach, CA, 90803, US

(21) Appl. No.: 11/650,383

(22) Filed: Jan. 8, 2007

(51) Int. Cl. A61C 3/00; A61C 5/04

(52) U.S. Cl. 433/29; 433/30; 433/226

(57) ABSTRACT

The present invention is directed to a light directing and amplifying device for attachment to a dental curing device used in light cure bonding orthodontic brackets to teeth wherein an internal mirror directs the light 90 degrees from the light source, directly under the back side of the bracket, thus directly curing the light cure adhesive enhancing the cure and rate of cure.

### BACKGROUND OF THE INVENTION

Photo curable dental adhesives are frequently used to bond orthodontic brackets to teeth. The dental adhesives are cured by exposure to light from a dental curing device. Dental curing devices are used to create a beam of light of an appropriate wavelength to cause curing of photosensitive materials. Various sources of light have been used within curing lights. The source of light may be a halogen bulb, a Xenon bulb, plasma arc and, more recently, light emitting devices herein referred to as LEDs. Radiant energy is transmitted from the lamp in the lamp assembly through an optic light guide. Optic guides have been necessary on the larger dental curing lights due to the accessibility and size constraints of the mouth. Optic light guides are typically 8-13 mm in diameter, and utilize a round tip at the distal end.

The procedure of bonding metal brackets on teeth has posed a particular problem for the light cure technique. The bracket adhesive is on the back side of the orthodontic bracket, away from the line of sight of the dental curing light. More powerful lights are more effective in curing the adhesive under the orthodontic bracket, but are expensive, large, often cumbersome and generate considerable heat, requiring cooling fans.

LED dental curing lights have become increasingly more popular due to the fact they require little energy, generate very little heat and are compact and portable. Further, the LED light does not require cooling fans and holds a charge for an extended period of time. Another advantage of using LEDs as the light source arises from the fact that the emission spectrum of some LEDs, in particular, blue LEDs, are in a very narrow band which coincides with the peak of the absorption spectrum of camphorquinone, the most common photo activator in dental photosensitive materials. Because of the narrow band, almost all of the light energy reaching the material is useful in the process of activating polymerization. No unnecessary heat is applied to the tooth. One of the problems with LED curing lights, however, is that their light output intensity is relatively low. Because of the low light intensity output, LED-curing lights are at a disadvantage in the speed of cure as compared with more intense light sources, such as halogen bulbs, plasma arc or xenon light sources. Most existing LED curing lights do not provide a light output intensity of greater than 500 mW/cm², whereas curing lights using more typical light sources can reach outputs of 2,500 mW/cm².

The weaker dental curing lights, such as the LED light, have required the time-consuming extra step of curing the light cure adhesive from different angles in an attempt to reach behind the orthodontic bracket.

### SUMMARY OF THE INVENTION

The present invention is directed to a light directing and amplifying device for attachment to a dental curing device. Many of the dental curing devices have an optic light guide that transmits the light to the tooth surface. The present invention attaches to the end of the optic light guide and in turn transmits the light to the tooth surface. The optic light guides range in diameter from 8-14 mm. The invention is a hollow internally mirrored tube sized to fit the light-emitting end of each of the different sized optic light guides. The light directing and amplifying devise is also sized to fit dental curing lights, such as LED lights, which do not contain an external optic light guide. The mirrored internal surface of the invention reflects the light which increases, or amplifies, the light reaching the surface of the tooth.

The light directing and amplifying device is most useful for bonding metal orthodontic brackets to teeth wherein the light cure adhesive is on the tooth side of the orthodontic bracket. The embodiment of the light directing and amplifying device for bonding orthodontic brackets to teeth is comprised of an internally mirrored tubular body with a first end sized to fit the light source and a second end sized to fit over an orthodontic bracket. The second end has an internal curvature, ideally 45 degrees, which directs the light 90 degrees from the light source, directly under the backside of the bracket, thus directly curing the light cure adhesive. The result is the dental curing light need not be directed at the orthodontic bracket from multiple directions, which is time consuming. The light directing and amplifying device provides an amplified light which is directed simultaneously from the buccal and under the bracket base from the occlusal, mesial, gingival and distal directions. The result is a more thorough cure of the orthodontic bracket adhesive in a greatly reduced length of time.

In one embodiment, the light directing and amplifying device is opaque which shields the patient and operator from any harmful light rays. In another embodiment, the light directing and amplifying device is clear, allowing the operator to see the orthodontic bracket during the curing process. The clear may be amber colored which filters out any harmful light rays. In another embodiment, fiber optic strands are positioned longitudinally on the inner wall of the tubular body and turn inwards 90 degrees at the second end in order to direct the light under the bracket base.

The light directing and amplifying device is also useful in the curing of dental light cure restorations.

### DESCRIPTION OF THE DRAWINGS

FIG. 1 is a prospective view of a dental curing light;

FIG. 2 is a perspective view of a dental curing light placed over an orthodontic bracket;

FIG. 3 is a prospective view of the light amplifying and directing device;

FIG. 4 is a perspective view of the light amplifying and directing device and a dental curing light;

FIG. 5 is a prospective view of a light amplifying and directing device with a curved lip;

FIG. 6 is a perspective view of the light amplifying and directing device placed over an orthodontic bracket;

FIG. 7 is a perspective view of the light amplifying and directing device placed over an orthodontic bracket;

FIG. 8 is a perspective view of the light amplifying and directing device placed over an orthodontic bracket;

FIG. 9 is a perspective view of the light amplifying and directing device placed over an orthodontic bracket;

FIG. 10 is a prospective view of fiber optic tubes; and

FIG. 11 is a perspective view of a light amplifying and directing device containing fiber optic tubes placed over an orthodontic bracket.

### DETAILED DESCRIPTION OF THE INVENTION

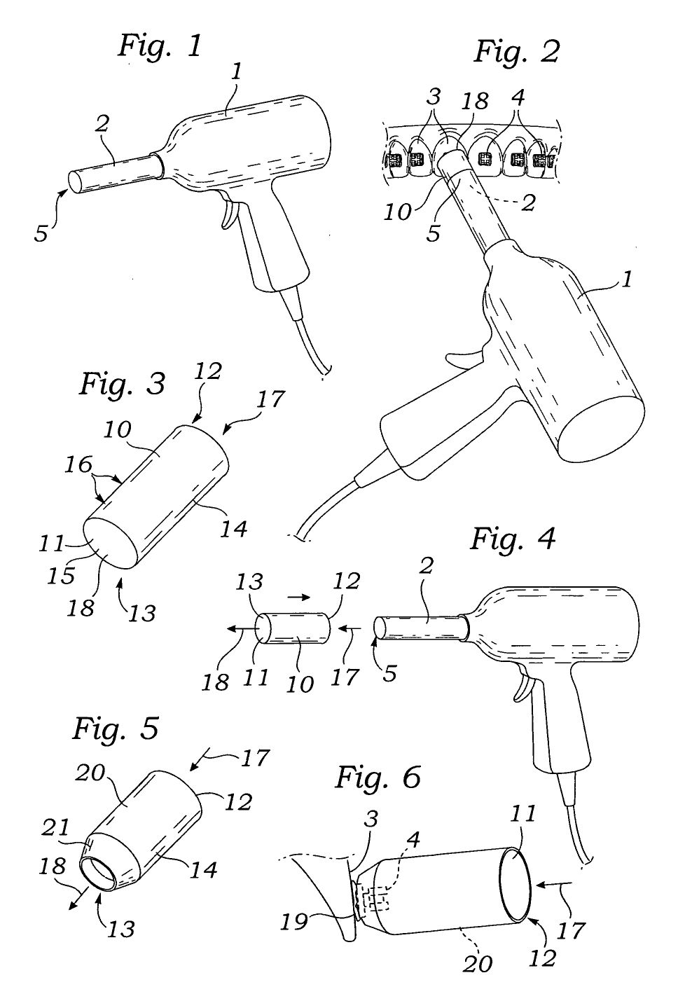

Referring to FIGS. 1, 2, 4 and 9 the light source for curing photosensitive light-cure dental fillings and adhesives is a dental curing device 1. The dental curing device 1 often contains an optic light guide 2 that carries the light to the tooth 3, as shown in FIGS. 2 and 9. Referring to FIG. 2, the light directing and amplifying device 10 is attached to the light emitting end 5 of the optic light guide 2 and the light directing and amplifying device 10 light outlet 18 is held over an orthodontic bracket 4 which has been placed on a tooth 3. The dental curing light 1 is activated until the light cure adhesive 19, as shown in FIG. 6, is hardened. In FIG. 3 an embodiment of the light directing and amplifying device 10 is comprised of a tubular body 16 with a light inlet 17 first end 12, a light outlet 18 second end 13, an exterior 14 and an interior 15 with a mirror coating 11. The mirror coating 11 amplifies the light. The embodiment in FIG. 3 is most useful for accelerating the cure time for light cure dental restorations.

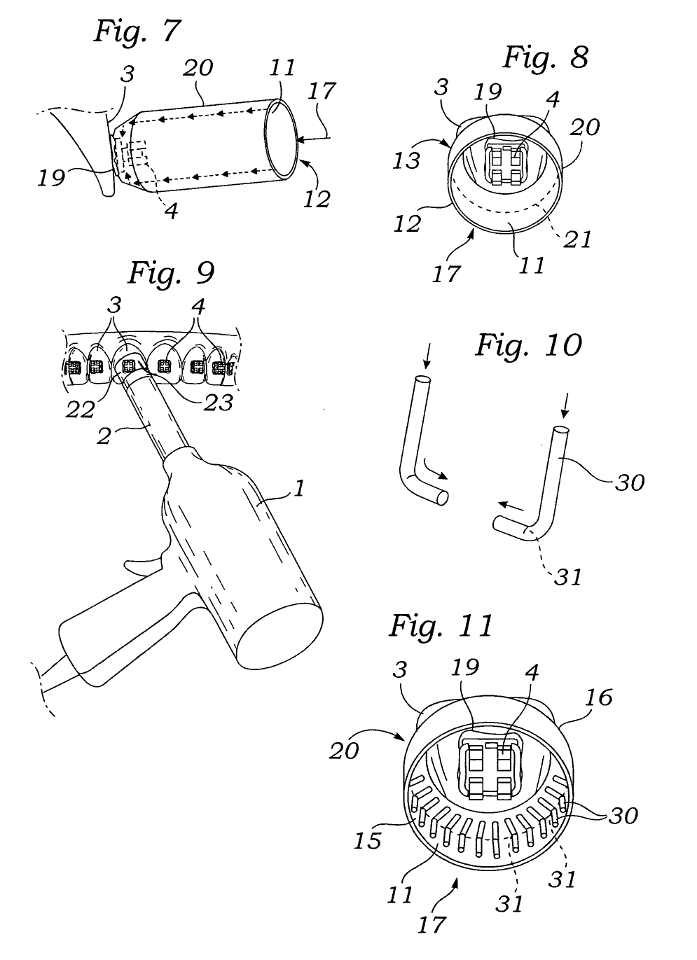

The preferred embodiment of the light directing and amplifying device with a lip 20 is disclosed in FIGS. 5-9 wherein the second end 13 of the tubular body 16 has an inner curvature, or lip 21, which is ideally at a 45 degree angle to the long axis of the tubular body 16. The 45 degree inner curvature 21 is mirror coated 11 reflecting at a right angle the light entering 17 the first end 12, as shown in FIGS. 6, 7, to light cure the adhesive 19 under the orthodontic bracket 4. The direction of the light source is changed and amplified by the use of the mirror coating 11.

In another embodiment, FIG. 9, the light directing and amplifying device 10 is comprised of a translucent tubular body 22 coated with an internal one way mirror 23. An enclosed orthodontic bracket 4 may be seen through the translucent tubular body 22 during the light curing procedure. The translucent tubular body 22 may be amber colored which protects the operator's eyes from any harmful effects of the curing light rays.

FIGS. 10, 11 disclose another embodiment of the light directing and amplifying device 10 wherein fiber optic fibers 30 are positioned longitudinally on the interior 15 wall of the tubular body 16. Each fiber optic fiber 30 has a right angle bend 31 at the lip end 20 of the tubular body 16 directing the light towards the enclosed orthodontic bracket 4 as shown in FIG. 11.

In the above embodiments, the light directing and amplifying device 10 may be removable or permanently affixed to the dental curing device 1. A clear plastic cover is often placed over a dental curing light 1 in order to prevent contamination of the dental curing device 1. Dental curing devices 1 are difficult or impossible to sterilize thoroughly. A light directing and amplifying device 10 attached to the light emitting tip of a dental curing device 1 prevents the light emitting end 5 of the dental curing light 1 from being contaminated. The second end 13, as shown in FIG. 3, of the light directing and amplifying device 10 may be left open, preventing a reduction in light intensity when the curing light clear plastic sleeve covers the end of the optic light guide 2. The light directing and amplifying device 10 holds the light emitting end 5 the dental curing device 1 from contacting the orthodontic bracket 4 and tooth 3.

The invention has been described with specific embodiments. However, the intent of the invention is to provide a light amplifier for light cure dental fillings. The further the intent of the invention is to provide a directional light source which is redirected to the underside of an orthodontic bracket 4 during the placement of an orthodontic bracket 4 upon a tooth 3.

What is claimed:

1. A light directing and amplifying device for attachment to a dental curing device with a light emitting end used in curing light cure adhesives used in the placement of an orthodontic bracket on a tooth comprising:
a tubular body with a first end, second end, an exterior, an interior and an axial center;
the tubular body first end configured for attachment to the light emitting end of a dental curing device;
the tubular body second end with an opening sized to fit over an orthodontic bracket; and
a mirror coating on the interior of the tubular body wherein the mirror amplifies the light transmitted to the light cure adhesive.

2. The light directing and amplifying device as in claim 1 wherein the light directing and amplifying device is removable from the dental curing device.

3. The light directing and amplifying device as in claim 1 wherein the light directing and amplifying device is integral with the dental curing device.

4. The light directing and amplifying device as in claim 1 wherein the tubular body is plastic.

5. The light directing and amplifying device as in claim 1 wherein the tubular body is translucent.

6. The light directing and amplifying device as in claim 4 wherein the tubular body is a tubular interior one-way mirror coating allowing the user to view the interior of the tubular body.

7. The light directing and amplifying device as in claim 6 wherein the translucent tubular body is amber colored in a shade that blocks any light wavelengths that would be harmful to the operator's eyes.

8. A light directing and amplifying device for attachment to a dental curing device with a light emitting end used in curing light cure adhesives used in the placement of an orthodontic bracket on a tooth comprising:
a tubular body with a first end, second end, an exterior, an interior and an axial center;
the tubular body first end configured for attachment to the light emitting end of a dental curing device;
the tubular body second end with an opening sized to fit over an orthodontic bracket;
an inner curvature of the second end of the tubular body towards the axial center; and
a mirror coating on the interior of the tubular body wherein the mirror amplifies the light and the inner curvature directs the light to the light cure adhesive under the orthodontic bracket.

9. The light directing and amplifying device as in claim 8 wherein the light directing and amplifying device is removable from the dental curing device.

10. The light directing and amplifying device as in claim 8 wherein the light directing and amplifying device is integral with the dental curing device.

11. The light directing and amplifying device as in claim 8 wherein the tubular body is plastic.

12. The light directing and amplifying device as in claim 8 wherein the tubular body is translucent.

13. The light directing and amplifying device as in claim 12 wherein the tubular body interior is a one-way mirror coating allowing the user to view the internal of the tubular body.

14. The light directing and amplifying device as in claim 13 wherein the translucent tubular body is amber colored in a shade that blocks any light wavelengths that would be harmful to the operator's eyes.

15. A light directing and amplifying device for attachment to a dental curing device with a light emitting end used in curing light cure adhesives used in the placement of an orthodontic bracket on a tooth comprising:
a tubular body with a first end, second end, an exterior, an interior and an axial center;
the tubular body first end configured for attachment to the light emitting end of a dental curing device;
the tubular body second end with an opening sized to fit over an orthodontic bracket;
a mirror coating on the interior of the tubular body; and
fiber optic fibers extending on the interior of the tubular body from the first end to the second end wherein the fiber optic fibers at the second end bend towards the axial center directing the light to the light cure adhesive under the orthodontic bracket.

16. The light directing and amplifying device as in claim 15 wherein the light directing and amplifying device is removable from the dental curing device.

17. The light directing and amplifying device as in claim 15 wherein the light directing and amplifying device is integral with the dental curing device.

18. The light directing and amplifying device as in claim 15 wherein the tubular body is plastic.

19. The light directing and amplifying device as in claim 15 wherein the tubular body is translucent.

20. The light directing and amplifying device as in claim 19 wherein the tubular body is comprised of an interior one-way mirror coating allowing the user to view the internal of the tubular body.

21. The light directing and amplifying device as in claim 20 wherein the translucent tubular body is amber colored in a shade that blocks any light wavelengths that would be harmful to the operator's eyes.

22. A method of bonding an orthodontic bracket to a tooth comprising:
inserting a light directing and amplifying device comprised of a tubular body, with a first end, second end, an exterior, and a mirrored interior, on the light emitting end of a dental curing device;
placing the light directing and amplifying device second over an orthodontic bracket that is attached to a mesh bracket pad wherein an orthodontic adhesive is placed between the mesh bracket pad and the surface of the tooth; and
hardening the orthodontic adhesive by turning the dental curing device on which bonds the orthodontic bracket to the surface of the tooth.
